(19) United States
(12) Patent Application Publication
(10) Pub. No.: US 2026/0265645 A1
(43) Pub. Date: Sep. 10, 2026

(54) CLEANING COMPOSITION FOR RECYCLING OF PLASTICS

(71) Applicants: Dow Global Technologies LLC, Midland, MI (US); Dow Quimica De Colombia S.A., Bogota (CO); Dow Quimica Mexicana S.A.de C.V., Ciudad De Mexico (MX)

(72) Inventors: Chelsea Clark, Pearland, TX (US); Paola K. Sanabria Ramirez, Bogota (CO); Julibeth M. Martinez, Lake Jackson, TX (US); Milena M. Avancini, Jundiai (BR); Xinjie Tong, Sugar Land, TX (US); Micol Federica Tresoldi, Lake Jackson, TX (US); Peilin Yang, Pearland, TX (US); Juan Pablo Watty Garcia, Alvaro Obregon (MX)

(21) Appl. No.: 18/875,353

(22) PCT Filed: Jul. 21, 2023
(86) PCT No.: PCT/US2023/028307

§ 371 Date: Dec. 16, 2024

Related U.S. Application Data
(60) Provisional application No. 63/390,985, filed on Jul. 21, 2022.

(51) Int. Cl. C11D 1/72; C11D 3/20

(52) U.S. Cl. CPC C11D 1/72; C11D 3/2068; C11D 2111/40

(57) ABSTRACT

A cleaning composition includes a surfactant having a cloud point of 60° C. or greater and a glycol ether having a hydrophilic-lipophilic balance (HLB) from 6 to 10. The glycol ether has an HLB of less than 7.5 if the surfactant has a cloud point of greater than 90° C., or the glycol ether has an HLB of greater than 8.5 if the surfactant has a cloud point from 60° C. to less than 75° C., or the glycol ether has an HLB of 7 to 9 if the surfactant has a cloud point from 75° C. to 90° C.

### BACKGROUND

### Field of the Disclosure

The present disclosure relates to cleaning compositions, and more specifically to cleaning compositions for recycled plastics.

### INTRODUCTION

The production and use of recycled plastic is a growing market. The commercial production of recycled plastics is accomplished through mechanical recycling. Mechanical recycling involves grinding, washing and drying post-consumer plastics to produce clean plastic flakes that can be converted into new products. During the washing step, it is necessary to use a high-temperature process of around 80° C., a washing solution composed of additives such as surfactants and/or detergents, and caustic soda to remove contaminants. Of particular concern for removal is the adhesive used for labeling bottles. The removal of the adhesive and other contaminants is important as these contaminants may negatively affect the recycled plastic's properties (i.e., haze, mechanical properties, etc.). At a minimum, a cleaning composition should remove 50% or more of the residual adhesives in order to render the recycled plastic useable.

In cleaning compositions utilizing surfactants, a cloud point of the surfactant should be within ±5° C. of the target cleaning temperature for maximum detergency. If a cloud point of the surfactant is too far above or below the temperature it is being used to clean at, the surfactant loses its detergency ability. Complicating the cloud point and detergency issue is the fact that the inclusion of a caustic soda to cleaning solutions containing surfactants tends to depress the cloud point of the surfactant. Unfortunately, the depression of the cloud point by the caustic soda is dependent on the amount of caustic soda present and type of surfactant, but does not depress in a linear or predictable manner. Typical caustic soda concentrations in cleaning mixtures range from 1 wt % to 2 wt %. As such, cleaning composition comprising surfactants cannot be easily substituted between mechanical recycling operations using different amounts of caustic soda without a reformulation or trial and error testing which costs money and time. Further, simply substituting a higher cloud point surfactant to compensate for the depressed cloud point is undesirable as this can mean using a solid surfactant which adds additional handling problems and provides worse detergency performance. It would be desirable for the adhesive removal to not fluctuate more than 20% over the caustic soda range of 1 wt % to 2 wt %.

In view of the foregoing, it would be surprising to discover a cleaning composition that achieves 50% or greater removal of the adhesives and also exhibits an adhesive removal that does not fluctuate more than 20% over a caustic soda range of 1 wt % to 2 wt %.

### SUMMARY OF THE DISCLOSURE

The inventors of the present invention have surprisingly discovered a cleaning composition that achieves 50% or greater removal of the adhesives and also exhibits an adhesive removal that does not fluctuate more than 20% over a caustic soda range of 1 wt % to 2 wt %. The inventors of the present application have discovered the use of a glycol ether as a cosolvent with the surfactant provides enhanced performance for surfactants used with alkali salt. Specifically, the selection of a surfactant and glycol ether combination depends on a hydrophilic-lipophilic balance (“HLB”) of the glycol ether and the cloud point of the surfactant. For example, if the surfactant has a cloud point from greater than 90° C. to 105° C. then the glycol ether has an HLB of less than 7, or if the surfactant has a cloud point from 60° C. to less than 75° C. then the glycol ether has an HLB of 7 to 9, or if the surfactant has a cloud point from 75° C. to 90° C. then the glycol ether has an HLB of greater than 9. Advantageously, utilizing the specific combination of surfactant cloud point and glycol ether HLB values outlined above allows the cleaning composition to be substituted into different cleaning mixtures for recycled plastic without concern that different alkali salt concentrations will affect the cleaning composition's detergency. Further, use of the specific surfactant cloud point and glycol ether HLB combinations avoids the use of solid surfactants and their associated handling problems in high temperature wash environments as alkali salt cloud point depression is eliminated.

The present application is particularly useful in providing cleaning composition used in washing of polymeric materials.

According to a first feature of the present disclosure, a cleaning composition includes a surfactant having a cloud point of 60° C. or greater, and a glycol ether having a hydrophilic-lipophilic balance (HLB) from 6 to 10, wherein the glycol ether has an HLB of less than 7.5 if the surfactant has a cloud point of greater than 90° C., wherein the glycol ether has an HLB of greater than 8.5 if the surfactant has a cloud point from 60° C. to less than 75° C., wherein the glycol ether has an HLB of 7 to 9 if the surfactant has a cloud point from 75° C. to 90° C.

According to a second feature of the present disclosure, the surfactant is non-ionic.

According to a third feature of the present disclosure, the glycol ether is 25 wt % to 75 wt % of the total weight of the cleaning composition and the surfactant is 25 wt % to 75 wt % of the total weight of the cleaning composition.

According to a fourth feature of the present disclosure, the surfactant has a cloud point from 60° C. to less than 75° C. and the glycol ether has an HLB of 7 to 9.

According to a fifth feature of the present disclosure, the surfactant has a cloud point from 75° C. to 90° C. and the glycol ether has an HLB of greater than 9.

According to a sixth feature of the present disclosure, the surfactant has a cloud point from greater than 90° C. to 105° C. and the glycol ether has an HLB of less than 7.

According to a seventh feature of the present disclosure, the glycol ether is selected from the group consisting of diethylene glycol mono hexyl ether and tripropylene glycol mono n-butyl ether.

According to an eighth feature of the present disclosure, the surfactant is a C₁₂-C₁₅ secondary alcohol having an average of 15 moles of ethylene oxide.

According to a ninth feature of the present disclosure, a cleaning mixture, comprises 0.01 wt % to 2.00 wt % of the cleaning composition based on the total weight of the cleaning mixture, 0.01 wt % to 3.00 wt % an alkali salt based on the total weight of the cleaning mixture, and water.

According to a tenth feature of the present disclosure, a cleaning method, comprises the steps of adding a polymeric material to the cleaning mixture and washing the polymeric material in the cleaning mixture at a temperature from 60° C. to 90° C.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated.

Test methods refer to the most recent test method as of the priority date of this document unless a date is indicated with the test method number as a hyphenated two-digit number. References to test methods contain both a reference to the testing society and the test method number. Test method organizations are referenced by one of the following abbreviations: ASTM refers to ASTM International (formerly known as American Society for Testing and Materials); IEC refers to International Electrotechnical Commission; EN refers to European Norm; DIN refers to Deutsches Institut für Normung; and ISO refers to International Organization for Standards.

As used herein, the term weight percent (“wt %”) designates the percentage by weight a component is of a total weight of the polymeric composition unless otherwise specified.

As used herein, Chemical Abstract Services registration numbers (“CAS #”) refer to the unique numeric identifier as most recently assigned as of the priority date of this document to a chemical compound by the Chemical Abstracts Service.

### Cleaning Composition

The present disclosure is directed to a cleaning composition. The cleaning composition comprises a surfactant and a glycol ether. As will be explained in greater detail below, the surfactant has a cloud point of 60° C. or greater and the glycol ether has a hydrophilic-lipophilic balance (HLB) from 6 to 10. The combination of surfactant and glycol ether used in the cleaning composition are selected based on their cloud point and HLB, respectively. Specifically, the glycol ether has an HLB of less than 7.5 if the surfactant has a cloud point of greater than 90° C., the glycol ether has an HLB of greater than 8.5 if the surfactant has a cloud point from 60° C. to less than 75° C., and the glycol ether has an HLB of 7 to 9 if the surfactant has a cloud point from 75° C. to 90° C. In some examples, the surfactant has a cloud point from 60° C. to less than 75° C. and the glycol ether has an HLB of 7 to 9. In some examples, the surfactant has a cloud point from 75° C. to 90° C. and the glycol ether has an HLB of greater than 9. In some examples, the surfactant has a cloud point from greater than 90° C. to 105° C. and the glycol ether has an HLB of less than 7.

### Surfactant

The cleaning composition comprises the surfactant. As used herein, a surfactant is a compound that lowers the surface tension (or interfacial tension) between two materials. Specifically, surfactants comprise a hydrophobic moiety and a hydrophilic moiety. The cleaning composition may comprise from 25 wt % to 75 wt % of the surfactant based on a total weight of the cleaning composition. For example, the cleaning composition may comprise 25 wt % or greater, or 30 wt % or greater, or 35 wt % or greater, or 40 wt % or greater, or 45 wt % or greater, or 50 wt % or greater, or 55 wt % or greater, or 60 wt % or greater, or 65 wt % or greater, or 70 wt % or greater, while at the same time, 75 wt % or less, or 70 wt % or less, or 65 wt % or less, or 60 wt % or less, or 55 wt % or less, or 50 wt % or less, or 45 wt % or less, or 40 wt % or less, or 35 wt % or less, or 30 wt % or less of the surfactant based on a total weight of the cleaning composition.

The surfactant has a cloud point of 60° C. or greater as measured according to ASTM D2024-09. As cloud point measurements are unreliable above 100° C., surfactants cloud points may be reported as >100° C. indicating that the surfactant did not cloud at temperatures at 100° C. or below. The surfactant may have a cloud point of 60° C. or greater, or 62° C. or greater, or 64° C. or greater, or 66° C. or greater, or 68° C. or greater, or 70° C. or greater, or 72° C. or greater, or 74° C. or greater, or 76° C. or greater, or 78° C. or greater, or 80° C. or greater, or 82° C. or greater, or 84° C. or greater, or 86° C. or greater, or 88° C. or greater, or 90° C. or greater, or 92° C. or greater, or 94° C. or greater, or 96° C. or greater, or 98° C. or greater, or >100° C. as measured according to ASTM D2024-09.

A variety of surfactant types may be utilized in the cleaning composition. For example, the surfactant may be a C₂-C₂₀ linear or branched alkoxylated alcohol. The surfactant may comprise, on average, from 5 to 20 units of ethylene oxide and/or propylene oxide. The surfactant may comprise aromatic or phenyl moieties. The surfactant may be ionic. The surfactant may be non-ionic. In a specific example the surfactant is a C₁₂-C₁₅ secondary alcohol having an average of 15 moles of ethylene oxide. Examples of commercially available surfactants include TERGITOL™ 15-S-9, TERGITOL™ 15-S-12, TERGITOL™ 15-S-15, TRITON™ X-100, TERGITOL™ 23-6.5, TRITON™ DF-16 and TRITON™ DF-20 all available from The Dow Chemical Company, Midland, Michigan.

### Glycol Ether

The cleaning composition comprises the glycol ether. As used herein, a glycol ether is an alkyl ether of ethylene glycol or propylene glycol. The cleaning composition may comprise from 25 wt % to 75 wt % of the glycol ether based on a total weight of the cleaning composition. For example, the cleaning composition may comprise 25 wt % or greater, or 30 wt % or greater, or 35 wt % or greater, or 40 wt % or greater, or 45 wt % or greater, or 50 wt % or greater, or 55 wt % or greater, or 60 wt % or greater, or 65 wt % or greater, or 70 wt % or greater, while at the same time, 75 wt % or less, or 70 wt % or less, or 65 wt % or less, or 60 wt % or less, or 55 wt % or less, or 50 wt % or less, or 45 wt % or less, or 40 wt % or less, or 35 wt % or less, or 30 wt % or less of the glycol ether based on a total weight of the cleaning composition.

The glycol ether has an HLB of 6.0 to 10.0 as measured according to the Davies HLB test method described in greater detail below. For example, the glycol ether may have an HLB of 6.0 or greater, or 6.2 or greater, or 6.4 or greater, or 6.6 or greater, or 6.8 or greater, or 7.0 or greater, or 7.2 or greater, or 7.4 or greater, or 7.6 or greater, or 7.8 or greater, or 8.0 or greater, or 8.2 or greater, or 8.4 or greater, or 8.6 or greater, or 8.8 or greater, or 9.0 or greater, or 9.2 or greater, or 9.4 or greater, or 9.6 or greater, or 9.8 or greater, while at the same time, 10.0 or less, or 9.8 or less, or 9.6 or less, or 9.4 or less, or 9.2 or less, or 9.0 or less, or 8.8 or less, or 8.6 or less, or 8.4 or less, or 8.2 or less, or 8.0 or less, or 7.8 or less, or 7.6 or less, or 7.4 or less, or 7.2 or less, or 7.0 or less, or 6.8 or less, or 6.6 or less, or 6.4 or less, or 6.2 or less as measured according to the Davies HLB test method described in greater detail below.

A variety of glycol ethers may be used in the cleaning composition. For example, the glycol ether may comprise ethylene glycol mono hexyl ether, tripropylene glycol mono n-butyl ether, diethylene glycol mono hexyl ether, dipropylene glycol mono n-butyl ether, propylene glycol mono n-butyl ether, dipropylene glycol dimethyl ether, propylene glycol phenyl ether, dipropylene glycol mono propyl ether, ethylene glycol mono butyl ether, propylene glycol mono propyl ether, ethylene glycol phenyl ether, diethylene glycol mono butyl ether, ethylene glycol mono propyl ether, diethylene glycol monophenyl ether, triethylene glycol monobutyl ether, tripropylene glycol mono methyl ether, dipropylene glycol mono methyl ether, triethylene glycol monoethyl ether, triethylene glycol monomethyl ether, and/or other glycol ethers. Examples of commercially available glycol ethers that may be used in the cleaning composition include Hexyl CELLOSOLVE™, DOWANOL™ TPnB, Hexyl CARBITOL™, DOWANOL™ DPnB, DOWANOL™ PnB, PROGLYDE™ DMM Glycol, DOWANOL™ PPh, DOWANOL™ DPnP, Butyl CELLOSOLVE™, DOWANOL™ PnP, DOWANOL™ Eph, Butyl CARBITOL™, Propyl CELLOSOLVE™ Solvent, DOWANOL™ DIEPh, Butoxytriglycol, DOWANOL™ TPM, DOWANOL™ DPM all of which are available from The Dow Chemical Company, Midland Michigan.

### Additives

The cleaning composition may comprise one or more additives. The cleaning composition may comprise from 0 wt % to 20 wt % of each additive based on the total weight of the cleaning composition. For example, the cleaning composition may comprise 0 wt % or greater, or 1 wt % or greater, or 2 wt % or greater, or 3 wt % or greater, or 4 wt % or greater, or 5 wt % or greater, or 6 wt % or greater, or 7 wt % or greater, or 8 wt % or greater, or 9 wt % or greater, or 10 wt % or greater, or 11 wt % or greater, or 12 wt % or greater, or 13 wt % or greater, or 14 wt % or greater, or 15 wt % or greater, or 16 wt % or greater, or 17 wt % or greater, or 18 wt % or greater, or 19 wt % or greater, while at the same time, 20 wt % or less, or 19 wt % or less, or 18 wt % or less, or 17 wt % or less, or 16 wt % or less, or 15 wt % or less, or 14 wt % or less, or 13 wt % or less, or 12 wt % or less, or 11 wt % or less, or 10 wt % or less, or 9 wt % or less, or 8 wt % or less, or 7 wt % or less, or 6 wt % or less, or 5 wt % or less, or 4 wt % or less, or 3 wt % or less, or 2 wt % or less, or 1 wt % or less of the additive based on the total weight of the cleaning composition. The additives may include one or more diluents such as water, propylene glycol and/or other diluents. The additives may include one or more hydrotropes such as octenyl succinic acid. The additives may include one or more defoaming and/or wetting agents such as surfactants or high molecular weight polyglycols. The additives may include one or more water soluble acrylic copolymers. The additives may include one or more chelating agents such as ethylenediaminetetraacetic (“EDTA”) acid, citric acid, potassium citrate, sodium citrate, tetrasodium ethylene-diaminetetraacetate, tetrasodium ethylene-diaminetetraacetate, tetrasodium ethylene-diaminetetraacetate, diammonium ethylene-diaminetetraacetate, tetrasodium ethylene-diaminetetraacetate, tetrasodium ethylene-diaminetetraacetate tetrahydrate, disodium ethylene-diaminetetraacetate tetrahydrate, ethylenediaminetetraacetic acid, disodium ethylene-diaminetetraacetate dihydrate, calcium disodium ethylene-diaminetetraacetate dihydrate, pentasodium diethylenetriaminepentaacetate, pentasodium diethylene-triaminepentaacetate, trisodium n-(hydroxyethyl)-ethylenediaminetriacetate, iron disodium n-(hydroxyethyl)-ethylenediaminetriacetate, ethylenediaminetetraacetic acid and combinations thereof.

### Cleaning Mixture

The present disclosure is also directed to a cleaning mixture. The cleaning mixture is mixture of the cleaning composition and an alkali salt. The alkali salt is selected from the group consisting of sodium hydroxide, potassium hydroxide, calcium hydroxide, magnesium hydroxide and/or combinations thereof. The cleaning mixture may comprise from 0.01 wt % to 2.00 wt % of the cleaning composition based on a total weight of the cleaning mixture. For example, the cleaning mixture may comprise 0.01 wt % or greater, or 0.25 wt % or greater, or 0.50 wt % or greater, or 0.75 wt % or greater, or 1.00 wt % or greater, or 1.25 wt % or greater, or 1.50 wt % or greater, or 1.75 wt % or greater, while at the same time, 2.00 wt % or less, or 1.75 wt % or less, or 1.50 wt % or less, or 1.25 wt % or less, or 1.00 wt % or less, or 0.75 wt % or less, or 0.50 wt % or less, or 0.25 wt % or less of the cleaning composition based on the total weight of the cleaning mixture.

The cleaning mixture may comprise from 0.01 wt % to 3.00 wt % of the alkali salt based on a total weight of the cleaning mixture. For example, the cleaning mixture may comprise 0.01 wt % or greater, or 0.25 wt % or greater, or 0.50 wt % or greater, or 0.75 wt % or greater, or 1.00 wt % or greater, or 1.25 wt % or greater, or 1.50 wt % or greater, or 1.75 wt % or greater, or 2.00 wt % or greater, or 2.25 wt % or greater, or 2.50 wt % or greater, or 2.75 wt % or greater, while at the same time, 3.00 wt % or less, or 2.75 wt % or less, or 2.50 wt % or less, or 2.25 wt % or less, or 2.00 wt % or less, or 1.75 wt % or less, or 1.50 wt % or less, or 1.25 wt % or less, or 1.00 wt % or less, or 0.75 wt % or less, or 0.50 wt % or less, or 0.25 wt % or less of the alkali salt based on the total weight of the cleaning mixture.

The balance of the cleaning composition may be water or other diluents.

### Cleaning Method

The present disclosure is also directed to a cleaning method utilizing the cleaning mixture. The cleaning method of the present disclosure comprises the step of adding a polymeric material to the cleaning mixture. The polymeric material may be post-consumer recycled thermoplastic such as polyethylene terephthalate, high density polyethylene, biaxially oriented polypropylene, etc. The polymeric material may be processed into flakes, chips and/or pellets. The polymeric material may be contaminated with adhesives, food waste, dirt and other grime.

The cleaning method also comprises a step of washing the polymeric material in the cleaning mixture at a temperature from 60° C. to 90° C. The cleaning mixture may be at a temperature of 60° C. or greater, or 65° C. or greater, or 70° C. or greater, or 75° C. or greater, or 80° C. or greater, or 85° C. or greater, while at the same time, 90° C. or less, or 85° C. or less, or 80° C. or less, or 75° C. or less, or 70° C. or less, or 65° C. or less. The step of washing the polymeric material may include agitation, mixing, stirring and/or ultrasonic vibration of the cleaning mixture. Mechanical scrubbing of the polymeric material may also be utilized in the step of washing the polymeric material.

The cleaning method removes adhesives present on the polymeric material. The cleaning method removes a percentage of adhesives present on the polymeric material. For example, the adhesive removal from the polymeric material accomplished by the cleaning method may be 50% or greater, or 55% or greater, or 60% or greater, or 65% or greater, or 70% or greater, or 75% or greater, or 80% or greater, or 85% or greater, or 90% or greater, or 95% or greater, or 100%.

The cleaning method may use cleaning mixtures having a range of alkali salt concentrations. Over a cleaning mixture alkali salt concentration of 1 wt % to 2 wt %, the adhesive removal ability of the cleaning mixture and method varies 20% or less as measured between the highest adhesive removal and the lowest adhesive removal values obtained in that range.

### EXAMPLES

### Materials

The materials used in the Examples are provided in Table 1. All materials are sourced from The Dow Chemical Company, Midland, Michigan.

TABLE 1

| Tradename or | | | Cloud |
|---|---|---|---|
| chemical name | Chemical Description, | HLB | point (° C.) |
| TERGITOL ™ 15-S-9 | C12-14-secondary alcohols ethoxylated, 9 moles EO | | 60 |
| TERGITOL ™ 15-S-12 | C12-14-secondary alcohols ethoxylated, 12 moles DO | | 89 |
| TERGITOL ™ 15-S-15 | C12-14-secondary alcohols ethoxylated, 15 moles EO | | >100 |
| TRITON ™ X-100 | Polyethylene glycol octylphenyl ether, 9.5 moles EO | | 66 |
| TERGITOL ™ 23-6.5 | C12-C13 linear Primary alcohol ethoxylated with 6.5 EO | | 46 |
| Hexyl CELLOSOLVE ™ | Ethylene glycol mono hexyl ether | 6.4 | |
| DOWANOL TPnB | Tripropylene glycol mono n-butyl ether | 6.63 | |
| Hexyl CARBITOL ™ | Diethylene glycol mono hexyl ether | 6.75 | |
| DOWANOL DPnB | Dipropylene glycol mono n-butyl ether | 6.75 | |
| DOWANOL PnB | Propylene glycol mono n-butyl ether | 6.88 | |
| PROGLYDE ™ DMM | Dipropylene glycol dimethyl ether | 7.1 | |
| Glycol | | | |
| DOWANOL ™ PPh | Propylene glycol phenyl ether | 7.11 | |
| DOWANOL ™ DPnP | Dipropylene glycol mono propyl ether | 7.23 | |
| Butyl CELLOSOLVE ™ | Ethylene glycol mono butyl ether | 7.35 | |
| DOWANOL ™ PnP | Propylene glycol mono propyl ether | 7.35 | |
| DOWANOL ™ EPh | Ethylene glycol phenyl ether | 7.59 | |
| Butyl CARBITOL ™ | Diethylene glycol mono butyl ether | 7.73 | |
| Propyl | Ethylene glycol mono propyl ether | 7.83 | |
| CELLOSOLVE ™ | | | |
| DOWANOL ™ DiEPh | Diethylene glycol monophenyl ether | 7.94 | |
| Butoxytriglycol | Triethylene glycol monobutyl ether | 8.05 | |
| DOWANOL ™ TPM | Tripropylene glycol mono methyl ether | 8.05 | |
| DOWANOL ™ DPM | Dipropylene glycol mono methyl ether | 8.18 | |
| Ethoxytriglycol | Triethylene glycol monoethyl ether | 9 | |
| Methoxytriglycol | Triethylene glycol monomethyl ether | 9.48 | |
| UCON ™ 50-HB-5100 | Polyalkylene glycol monobutyl ether (PPG-33-Buteth-45) | | |
| Propylene glycol | C₃H₈O₂ | | |
| Water | H₂O | | |

Table 2 provides a description of the adhesives used in the examples.

TABLE 2

| Adhesive Type | Name | Type | Source |
|---|---|---|---|
| Adhesive 1 | PHL-4150-ZP | Styrenic PSA | HB Fuller |
| Adhesive 2 | HM 8535 | Styrenic PSA | Warren/Heigl |
| Adhesive 3 | ROBOND ™ PS-8915M | Acrylic PSA | The Dow Chemical Company |
| Adhesive 4 | ROBOND ™ PS-7874K | Acrylic PSA | The Dow Chemical Company |

### Test Methods

Davies HLB: Hydrophile-lipophile balance (HLB) values were calculated using Davies' group contribution method (J. T. Davies, E. K. Rideal, Interfacial Phenomena, Academic Press, New York, 1961, p. 371). This method assumes that HLB values are given by:

$$HLB = 7 + \sum ( {G}_{i} * {N}_{i} )$$

Gᵢ represents group contributions for the different hydrophilic and lipophilic groups in the molecule, and Nᵢ represents how many times that particular group is present in the molecule. Table 3 shows the different hydrophilic and lipophilic groups considered for these calculations, and their group contribution.

TABLE 3

| Hydrophilic and lipophilic groups | Group Contribution (Gᵢ) |
|---|---|
| Hydroxyl | 1.9 |
| Ether Oxygen | 1.3 |
| Alkyl | −0.475 |
| Ethylene Oxide | 0.35 |
| Propylene Oxide | −0.125 |
| Phenyl | −1.662 |
| Ester | 2.4 |

Cloud Point: Cloud point was measured according to ASTM D2024-09.

### Sample Preparation

Polyethylene Terephthalate (“PET”) (obtained from ePlastics, San Diego, California, USA) and Biaxially Oriented Polypropylene (obtained from Multi Plastics Inc., Lewis Center, Ohio, USA) substrates were coated with either an acrylic pressure-sensitive adhesive or a styrenic pressure-sensitive adhesive as a thin film. The styrenic adhesive was applied to the substrates using a HLCL-1000 hot melt coater laminator from Cheminstruments and the acrylic adhesive was applied to the substrates using a drawdown coater. Next, some samples were laminated with a silicone-coated release liner to protect the adhesive film while others were laminated with a BOPP film. Following coating, each sample was allowed to cure for at least 48 hours prior to use. After curing, the samples were cut manually into 7.62 cm by 3.81 cm pieces, where each sample had a nominal loading of about 15-20 grams of adhesive per square meter or GSM (approx. 40-50 mg/sample). The silicon-coated release liner was removed directly prior to the washing experiments in order to prevent dirt accumulation on the coated surface.

In the case of the BOPP-laminated samples, the PET was laminated with 1.9 mm thick BOPP film rather than the silicon-coated release liner. These samples were cut into ~1 cm×1 cm squares prior to addition to the cleaning mixture.

After sample preparation and curing, 800 g of each inventive or comparative cleaning mixture was pre-heated to ~70° C. in a 1 L Pyrex bottle. The solutions typically included: 0.5 wt % to 2 wt. % of 40 wt % NaOH in water as indicated, 0.05 wt % to 1 wt % of the cleaning composition, and water. After preheating, the solution was poured into a 1 L beaker then further heated to 80° C. while stirring. Once at the desired temperature, the substrate samples were washed for 8 minutes at a stirring rate of 500 revolutions per minute. For each example, samples were washed in triplicate with a blank (no adhesive) for a total of four samples per beaker.

After the washing step, the samples were rinsed at 21° C. in a beaker containing 500 mL of deionized water for 3 minutes using an agitation speed of 400 revolutions per minute.

After rinsing, the samples were laid flat in a metal tray and dried for approximately 16 hours at a temperature of 40° C. to 45° C. under high convection. The following day, the samples were allowed to come to about 23° C. temperature completely prior to weighing.

The BOPP-laminated samples were washed in a similar manner; however, in this case 40 grams of the flakes were washed in only 400 g of solution. All of the following steps were performed the same.

Quantification of the adhesive removal was determined using Equation 1:

$$Adhesive removal = ( \frac{{w}_{2} - {w}_{3}}{{w}_{2} - {w}_{1}} ) \times 100 \% \qquad Eq . 1$$

where w₁ is the weight of the substrate without adhesive, w₂ is the weight of the substrate with the adhesive and w₃ is the weight of the substrate after washing, rinsing, and drying. The adhesive removal is reported with the potential measurement error. It should be noted that adhesive removal percentages in excess of 100% are a result of additional contamination adhering to the test substrates.

### Results

Table 4 provides the results of the inventive examples (“IE”) and the comparative examples (“CE”). Specifically, the results of Table 3 were obtained under the following testing conditions: substrate is PET, NaOH dosage was 1 wt %, temperature was 80° C., washing additive is 50 wt % of the indicated surfactant and 50 wt % of the indicated glycol ether, adhesive type is type 1 and the balance of the cleaning mixture used was water.

TABLE 4

| | Cleaning | | Surfactant | | GE | % of |
|---|---|---|---|---|---|---|
| | Composition | | Cloud | | Davies | Adhesive |
| Ex. | (wt %) | Surfactant | Point | Glycol Ether (GE) | HLB | Removal |
| CE1 | 0.20% | TERGITOL ™ | 60° C. | Hexyl CARBITOL ™ | 6.75 | 34.54 ± |
| | | 15-S-9 | | | | 6.06% |
| CE2 | 0.10% | TERGITOL ™ | 60° C. | N/A | N/A | 35.2% ± |
| | | 15-S-9 | | | | 11.2% |
| CE3 | 0.30% | TERGITOL ™ | 46° C. | Butyl CARBITOL ™ | 7.73 | 38.93 ± |
| | | 23-6.5 | | | | 0.74% |
| CE4 | 0.20% | TERGITOL ™ | >100° C. | Ethoxytriglycol | 9 | 47.70 ± |
| | | 15-S-15 | | | | 10.75% |
| IE1 | 0.20% | TERGITOL ™ | 60° C. | Ethoxytriglycol | 9 | 48.42 ± |
| | | 15-S-9 | | | | 10.25% |
| CE5 | 0.10% | TERGITOL ™ | >100° C. | N/A | N/A | 51.9% ± |
| | | 15-S-15 | | | | 8.3% |
| CE6 | 0.20% | TERGITOL ™ | >100° C. | Butyl CARBITOL ™ | 7.73 | 51.90 ± |
| | | 15-S-15 | | | | 25.07% |
| CE7 | 0.20% | TERGITOL ™ | >100° C. | Butoxytriglycol | 8.05 | 54.04 ± |
| | | 15-S-15 | | | | 25.58% |
| CE8 | 0.20% | TERGITOL ™ | >100° C. | DOWANOL ™ TPM | 8.05 | 56.67 ± |
| | | 15-S-15 | | | | 17.94% |
| CE9 | 0.20% | TERGITOL ™ | >100° C. | Propyl CELLOSOLVE ™ | 7.83 | 56.91 ± |
| | | 15-S-15 | | Solvent | | 27.25% |
| IE2 | 0.20% | TERGITOL ™ | >100° C. | PROGLYDE ™ DMM | 7.1 | 57.24 ± |
| | | 15-S-15 | | Glycol | | 7.23% |
| CE10 | 0.20% | TERGITOL ™ | >100° C. | DOWANOL ™ DPM | 8.18 | 57.48 ± |
| | | 15-S-15 | | | | 29.37% |
| CE11 | 0.20% | TRITON ™ X- | 66° C. | Hexyl CARBITOL ™ | 6.75 | 61.16 ± |
| | | 100 | | | | 7.64% |
| CE12 | 0.20% | TERGITOL ™ | >100° C. | DOWANOL ™ EPh | 7.59 | 64.74 ± |
| | | 15-S-15 | | | | 23.28% |
| IE3 | 0.20% | TERGITOL ™ | >100° C. | DOWANOL ™ PnP | 7.35 | 72.40 ± |
| | | 15-S-15 | | | | 16.46% |
| CE13 | 0.20% | TERGITOL ™ | 89° C. | Hexyl CARBITOL ™ | 6.75 | 72.74 ± |
| | | 15-S-12 | | | | 18.55% |
| IE4 | 0.20% | TERGITOL ™ | >100° C. | Butyl CELLOSOLVE ™ | 7.35 | 75.08 ± |
| | | 15-S-15 | | | | 10.72% |
| CE14 | 0.20% | TERGITOL ™ | >100° C. | DOWANOL ™ DiEPh | 7.94 | 76.14 ± |
| | | 15-S-15 | | | | 22.49% |
| IE5 | 0.20% | TERGITOL ™ | >100° C. | DOWANOL PnB | 6.88 | 78.08 ± |
| | | 15-S-15 | | | | 22.09% |
| IE6 | 0.20% | TERGITOL ™ | >100° C. | DOWANOL ™ DPnP | 7.23 | 79.32 ± |
| | | 15-S-15 | | | | 13.48% |
| IE7 | 0.20% | TERGITOL ™ | >100° C. | DOWANOL DPnB | 6.75 | 83.72 ± |
| | | 15-S-15 | | | | 18.45% |
| IE8 | 0.20% | TERGITOL ™ | 89° C. | Ethoxytriglycol | 9 | 85.87 ± |
| | | 15-S-12 | | | | 15.17% |
| IE9 | 0.20% | TERGITOL ™ | >100° C. | DOWANOL PPh | 7.11 | 86.62 ± |
| | | 15-S-15 | | | | 17.71% |
| IE10 | 0.20% | TRITON ™ X- | 66° C. | Ethoxytriglycol | 9 | 89.28 ± |
| | | 100 | | | | 4.19% |
| IE11 | 0.20% | TERGITOL ™ | >100° C. | DOWANOL TPnB | 6.63 | 89.33 ± |
| | | 15-S-15 | | | | 15.67% |
| CE15 | 0.10% | TERGITOL ™ | 89° C. | N/A | N/A | 90.2% ± |
| | | 15-S-12 | | | | 9.2% |
| IE12 | 0.20% | TERGITOL ™ | 89° C. | DOWANOL ™ TPM | 8.05 | 91.06 ± |
| | | 15-S-12 | | | | 6.85% |
| IE13 | 0.20% | TERGITOL ™ | 89° C. | Butyl CELLOSOLVE ™ | 7.35 | 92.42 ± |
| | | 15-S-12 | | | | 11.26% |
| IE14 | 0.20% | TERGITOL ™ | >100° C. | Hexyl CARBITOL ™ | 6.75 | 94.74 ± |
| | | 15-S-15 | | | | 8.61% |
| IE15 | 0.20% | TERGITOL ™ | >100° C. | Hexyl CELLOSOLVE ™ | 6.4 | 97.93 ± |
| | | 15-S-15 | | | | 5.26% |

As can be seen from Table 4, the inventive examples are able to provide greater than 50% adhesive removal when the NaOH concentration is kept constant. While IE1 is technically below the 50% cut-off range, the measurement error of 10.25% suggests that the true value may be above 50%. Notably, IE1 demonstrates an improvement of about 13% over CE2. Although CE5-CE15 are able to achieve 50% adhesive removal or better, it is believed that the absence of a glycol ether or the absence of the specified surfactant cloud point and glycol ether HLB relationship means that the alteration of the NaOH concentration would have a negative and unpredictable effect on the adhesive removal.

Table 5 demonstrates the ability of the inventive examples to maintain cleaning performance across a spectrum of NaOH concentrations. The experiments of Table 5 were carried out under the following conditions: substrate was PET, temperature was 80° C., washing additive is 50 wt % of the indicated surfactant and 50 wt % of the indicated glycol ether, adhesive type was type 1 and the balance of the cleaning mixture used was water.

TABLE 5

| | Cleaning | | Surfactant | | | % of |
|---|---|---|---|---|---|---|
| | Composition | | Cloud | | NaOH | Adhesive |
| Ex. | (wt %) | Surfactant | Point | Glycol Ether (GE) | (wt %) | Removal |
| CE16 | 0.1% | TERGITOL ™ | >100° C. | N/A | 1.0 | 51.9% ± |
| | | 15-S-15 | | | | 8.3% |
| CE16 | 0.1% | TERGITOL ™ | >100° C. | N/A | 2.0 | 77.4 ± |
| | | 15-S-15 | | | | 4.0% |
| IE16 | 0.2% | TERGITOL ™ | >100° C. | Hexyl CARBITOL ™ | 1.0 | 94.74 ± |
| | | 15-S-15 | | | | 8.61% |
| IE16 | 0.2% | TERGITOL ™ | >100° C. | Hexyl CARBITOL ™ | 2.0 | 84.9 ± |
| | | 15-S-15 | | | | 9.1% |

Table 5 demonstrates that including an appropriate glycol ether with a surfactant having a higher than necessary cloud point (i.e., a cloud point in excess of the washing temperature) for 1-2 wt % NaOH concentration can impart good adhesive removal performance across the range of NaOH concentrations used for that material with no formulation changes required. Specifically, IE16 only exhibits a change of about 10% over the 1 wt % to 2 wt % NaOH concentration range. As shown, CE16 exhibits greater than 20% adhesive removal as NaOH is varied from 1 wt % to 2 wt % which is undesirable. It is believed that other cleaning compositions will exhibit less than 20% change in adhesive removal over the defined NaOH range if the cleaning composition has a glycol ether that has an HLB of less than 7.5 if the surfactant has a cloud point of greater than 90° C., or the glycol ether has an HLB of greater than 8.5 if the surfactant has a cloud point from 60° C. to less than 75° C., or the glycol ether has an HLB of 7 to 9 if the surfactant has a cloud point from 75° C. to 90° C.

Table 6 demonstrates the ability of the inventive examples to maintain cleaning performance across a variety of glycol ether to surfactant weight ratios. The experiments of Table 6 were carried out under the following conditions: substrate was PET, cleaning composition dosage was 0.2 wt %, NaOH concentration was 1 wt %, temperature was 80° C., adhesive type was type 1 and the balance of the cleaning mixture used was water.

TABLE 6

| | | | Glycol | |
|---|---|---|---|---|
| | | | ether:Surfactant | % Adhesive |
| Ex. | Surfactant | Glycol Ether | Ratio | Removal |
| IE17 | TERGITOL ™ 15-S-15 | Hexyl CARBITOL ™ | 1:9 | 66.99 ± 10% |
| IE18 | TERGITOL ™ 15-S-15 | Hexyl CARBITOL ™ | 9:1 | 94.10 ± 4.96% |
| IE19 | TERGITOL ™ 15-S-15 | Hexyl CARBITOL ™ | 1:1 | 94.74 ± 8.61% |

Table 7 demonstrates the ability of the inventive examples to maintain adhesive removal across a variety of cleaning composition concentrations in the cleaning mixture. The experiments of Table 7 were carried out under the following conditions: substrate was PET, NaOH concentration was 1 wt %, the Glycol ether to surfactant weight ratio was 1:1 temperature was 80° C., adhesive type was type 1 and the balance of the cleaning mixture used was water.

TABLE 7

| | | | Cleaning | |
|---|---|---|---|---|
| | | | Composition | % of Adhesive |
| Ex. | Surfactant | Glycol Ether | (wt %) | Removal |
| IE20 | TERGITOL ™ 15-S-15 | Hexyl CARBITOL ™ | 1.0 | 81.77 ± 18.08% |
| IE21 | TERGITOL ™ 15-S-15 | Hexyl CARBITOL ™ | 0.5 | 100.67 ± 0.58% |
| IE22 | TERGITOL ™ 15-S-15 | Hexyl CARBITOL ™ | 0.2 | 93.13 ± 13.1% |
| IE23 | TERGITOL ™ 15-S-15 | Hexyl CARBITOL ™ | 0.15 | 92.1% ± 12.6% |
| IE24 | TERGITOL ™ 15-S-15 | Hexyl CARBITOL ™ | 0.05 | 56.60 ± 13.77% |

1. A cleaning composition, comprising:
a surfactant having a cloud point of 60° C. or greater at a percent by weight (wt %) of the cleaning composition ranging from 25 wt % to 75 wt %; and
a glycol ether having a hydrophilic-lipophilic balance (HLB) from 6 to 10 and ranging from 25 wt % to 75 wt %,
wherein the glycol ether has an HLB of less than 7.5 if the surfactant has a cloud point of greater than 90° C.,
wherein the glycol ether has an HLB of greater than 8.5 if the surfactant has a cloud point from 60° C. to less than 75° C.,
wherein the glycol ether has an HLB of 7 to 9 if the surfactant has a cloud point from 75° C. to 90° C.

2. The cleaning composition of claim 1, wherein the surfactant is non-ionic.

3. (canceled)

4. (canceled)

5. (canceled)

6. (canceled)

7. The cleaning composition of claim 1, wherein the glycol ether is selected from the group consisting of diethylene glycol mono hexyl ether and tripropylene glycol mono n-butyl ether.

8. The cleaning composition of claim 7, wherein the surfactant is a C₁₂-C₁₅ secondary alcohol having an average of 15 moles of ethylene oxide.

9. A cleaning mixture, comprising:
0.01 wt % to 2.00 wt % based on the total weight of the cleaning mixture, a cleaning composition comprising a glycol ether selected from the group consisting of diethylene glycol mono hexyl ether and tripropylene glycol mono n-butyl ether; and a surfactant selected from C₁₂-C₁₅ secondary alcohols having an average of 15 moles of ethylene oxide;
0.01 wt % to 3.00 wt % an alkali salt based on the total weight of the cleaning mixture; and
water.

10. A cleaning method, comprising the steps of:
adding a polymeric material to a cleaning mixture comprising:
a cleaning composition at a percent by weight (wt %) of the cleaning mixture ranging from 0.01 wt % to 2.00 wt %; and
an alkali salt in a range of 0.01 wt % to 3.00 wt %;
wherein the cleaning composition comprises a surfactant having a cloud point of 60° C. or greater at a percent by weight (wt %) of the cleaning composition ranging from 25 wt % to 75 wt %; and a glycol ether having a hydrophilic-lipophilic balance (HLB) from 6 to 10 and ranging from 25 wt % to 75 wt %; and
washing the polymeric material in the cleaning mixture at a temperature from 60° C. to 90° C.

11. The method of claim 10, wherein the glycol ether has an HLB of less than 7.5 if the surfactant has a cloud point of greater than 90° C., wherein the glycol ether has an HLB of greater than 8.5 if the surfactant has a cloud point from 60° C. to less than 75° C., and wherein the glycol ether has an HLB of 7 to 9 if the surfactant has a cloud point from 75° C. to 90° C.
